(19) United States
(12) Patent Application Publication
(10) Pub. No.: US 2008/0187725 A1
(43) Pub. Date: Aug. 7, 2008

(54) FUNCTIONAL LAYERS FOR POLYCARBONATE GLAZING

(75) Inventors: SUNITHA GRANDHEE, Novi, MI (US); CHENGTAO LI, Novi, MI (US); KEITH D. WEISS, Fenton, MI (US); ERIC F.J.M. VAN DER MEULEN, Wixom, MI (US)

Correspondence Address: EXATEC;C/O BRINKS HOFER GILSON & LIONE, P. O. BOX 10395, CHICAGO, IL, 60610, US

(73) Assignee: Exatec, LLC, Wixom, MI (US)

(21) Appl. No.: 11/870,065

(22) Filed: Oct. 10, 2007

Related U.S. Application Data
(60) Provisional application No. 60/882,296, filed on Dec. 28, 2006.

(51) Int. Cl. B32B 33/00; C08J 7/04; B05D 5/00

(52) U.S. Cl. 428/195.1; 428/408; 428/336; 428/412; 427/532; 427/581; 427/585

(57) ABSTRACT

A plastic glazing for use in an automobile. The glazing includes a polycarbonate substrate, a conductive layer located adjacent to the polycarbonate substrate, and a glazing layer located adjacent to the conductive layer. The conductive layer comprises carbon nanotubes, and the glazing layer is made of a material that is different from polycarbonate. The glazing layer includes at least one of an abrasion resistant layer and a weathering layer.

### CROSS-REFERENCE TO RELATED APPLICATIONS

This application claims the benefit of U.S. Provisional Application Ser. No. 60/882,296 filed on Dec. 28, 2006, entitled “FUNCTIONAL LAYERS FOR POLYCARBONATE GLAZING,” the entire contents of which are incorporated herein by reference.

### BACKGROUND OF THE INVENTION

1. Field of the Invention

The present invention generally relates to plastic glazings for automobiles and to glazings that provide functions in addition to a wind and weather barrier.

2. Description of the Known Technology

Polycarbonate is becoming widely accepted as a desirable replacement for glass glazings in the automotive industry. Due to its superior strength, optical clarity, greater freedom in vehicle styling, and excellent thermal properties, polycarbonate is used in the manufacture of automotive window systems with specific functional features. However, the properties of polycarbonate glazings create challenges non-existent in glass glazings. For example, the polycarbonate glazings preferably must be protected against abrasion and, preferably, processes must be developed to incorporate various functional elements within polycarbonate glazings. Further, designers of polycarbonate windows must ensure adequate adhesion of glazings on a polycarbonate substrate.

A current technology used for defrosters and antennas is highly conductive ink that is printed on a polycarbonate substrate or plasma-coated polycarbonate substrate. This ink is usually opaque, and usually has a color, such as black. Typical printed ink defrosters defrost in an uneven pattern, wherein the portions of the window closest to the ink design are defrosted faster than other portions. Further, such ink designs are typically visible on windows, thereby decreasing the portion of the window that is transparent.

### BRIEF SUMMARY

The present invention provides a method by which functional layers may be provided on a polycarbonate substrate without the use of ink, allowing for a greater amount of transparency through a plastic panel. Further, the present invention provides a transparent functional layer having a polycarbonate substrate, while still providing the desired adhesiveness between the functional layer and the polycarbonate substrate.

In one aspect, a plastic panel or glazing suitable for use in an automobile is provided. The plastic panel has a polycarbonate substrate, a conductive layer located adjacent to the polycarbonate substrate, the conductive layer comprising carbon nanotubes, and a glazing layer located over the conductive layer. The glazing layer is formed of a material that is different from polycarbonate. The glazing layer includes one or both of a weathering layer and an abrasion resistant layer.

In another aspect, the plastic panel has a first polycarbonate substrate, a second polycarbonate substrate located adjacent to the first polycarbonate substrate, and a conductive layer disposed between the first and second polycarbonate substrates. The conductive layer comprises carbon nanotubes.

In yet another aspect, a method of creating a substrate assembly is provided. The method includes providing a first polycarbonate sheet, providing a conductive layer adjacent to the first polycarbonate sheet, and providing a second polycarbonate sheet adjacent to the conductive layer. The conductive layer comprises carbon nanotubes. The method further includes delivering heat adjacent to at least one of the first and second polycarbonate sheets to fuse the first and second polycarbonate plates together.

These and other aspects and advantages of the present invention will become apparent upon reading the following detailed description of the invention in combination with the accompanying drawings.

### BRIEF DESCRIPTION OF THE DRAWINGS

FIG. 1 is a plan view of a plastic glazing for use in an automotive window, in accordance with an embodiment of the present invention;

FIG. 2 is a diagrammatic cross-sectional view, generally along line 2-2 of the plastic glazing of FIG. 1, in accordance with an embodiment of the present invention;

FIG. 3 is a diagrammatic cross-sectional view of another plastic glazing, in accordance with an embodiment of the present invention;

FIG. 4 is an exploded cross-sectional view of a conductive layer of the plastic glazing of FIG. 3, in accordance with an embodiment of the present invention; and

FIG. 5 is a diagrammatic cross-sectional of yet another plastic glazing, in accordance with an embodiment of the present invention.

### DETAILED DESCRIPTION

Referring now to FIG. 1, an automotive plastic glazing 10, in accordance with an embodiment of the present invention, is illustrated in plan view. The plastic glazing 10 is comprised primarily of a plastic material and also includes multiple layers and/or coatings to provide various attributes necessary for the automotive glazing to operate in the environment of a motor vehicle, such as an automobile, light duty truck, rail, water or aircraft. Of course, the present invention contemplates other uses for the glazing 10 of the present invention. For example, the glazing 10 may be used in stationary objects such as dwellings and commercial buildings. In the automotive application, the plastic glazing 10 typically includes a transparent area 12 allowing a vehicle occupant to see through the plastic glazing 10. A non-transparent or blackout area 14 is also provided, typically along a perimeter of the plastic glazing 10, for aesthetic purposes. For example, the non-transparent or blackout area 14 may be used to hide mounting structures, fit and finish imperfections or just to improve the overall appearance of the vehicle. While the plastic glazing 10 may be substantially flat, the present invention, of course, contemplates that the plastic glazing 10 may be curved and formed into various shapes and sizes.

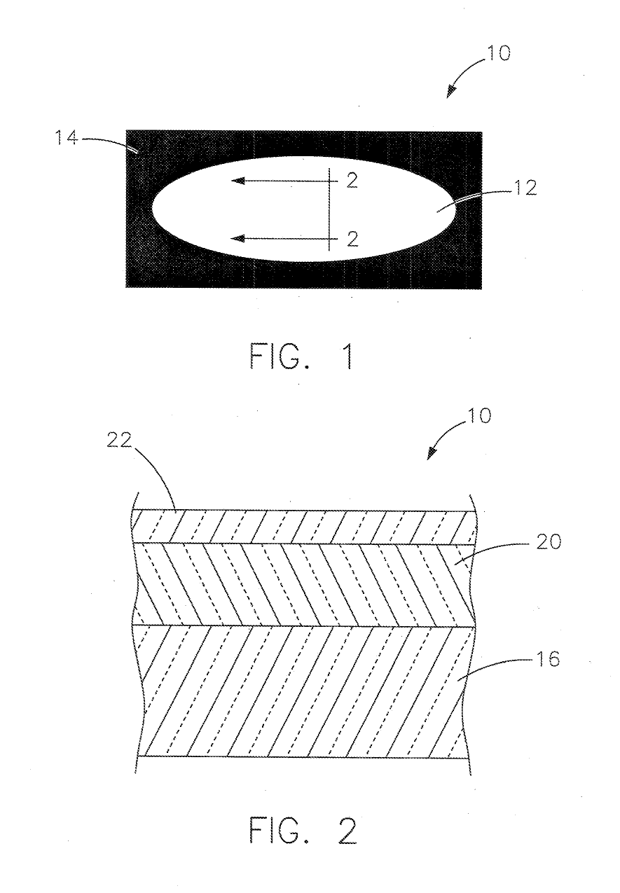

Referring now to FIG. 2, a diagrammatic cross-sectional view through the transparent area 12 of the plastic glazing 10 of FIG. 1 is illustrated therein. As shown in FIG. 2, the plastic glazing 10 includes multiple layers beginning with a substrate 16. Adjacent to the substrate 16 is a conductive layer 20 that may provide various functions, such as defrosting/defogging and solar control which will be described in further detail below. An outermost glazing layer or coating is applied to the conductive layer 20, in this embodiment, and is referred to herein as an abrasion resistant layer 22, which protects the other layers from damage caused by abrasion. In the alternative, the outermost glazing layer could be a weathering layer, which will be described in further detail below.

The substrate 16 is comprised substantially of polycarbonate and preferably has a thickness of between 3 and 6 millimeters. Further, the substrate 16 may include a privacy or solar tint resin for aesthetic purposes as well as for controlling the transmission of solar radiation through the glazing 10. The substrate 16 is formed into its desired shape using any of the various known techniques, such as molding, thermoforming, or extrusion.

The conductive layer 20 is located adjacent to the substrate 16. The conductive layer 20 may be disposed directly on the surface of the substrate 16, or the conductive layer 20 may be disposed upon other optional layers, such as a weathering layer or a decorative layer, that are disposed on the substrate 16. The conductive layer 20 of the present invention comprises carbon nanotubes and preferably has a thickness of less than 50 nm. The carbon nanotubes are used as electrically conductive particles that conduct electricity to form a functional layer. Carbon nanotubes have a higher strength, stiffness, and electrical conductivity as compared to metals. The conductive layer 20 functions as a transparent electric circuit, which may operate as a transparent defrosters/defogger, an antenna, rain sensors, light sensors, touch sensors, a photochromic light control layer, or an electroluminescent layer, among other uses.

Carbon nanotubes, of which the conductive layer 20 is comprised, may be provided in whole sheets. Typically, these sheets have about one-third of the carbon nanotubes being intrinsically conductive and about two-thirds of the carbon nanotubes being semiconducting. The sheets of carbon nanotubes are typically purified to remove large catalyst particles utilized in their formation, and the sheets may contain a dopant, such as a halogen or an alkali metal, to dope the semiconducting nanotubes with a suitable charge transfer species. Single-wall carbon nanotubes typically have an outside diameter of about 1 to 2 nm, and multi-wall carbon nanotubes typically have an outside diameter of about 8 to 12 nm. The carbon nanotubes may be layered by a manufacturer to produce a desired thickness.

While carbon nanotube sheets may be provided in any thickness desired, if the conductive layer 20 is sufficiently thin, it will remain transparent. Typically, sheets with a thickness of 100 nm or less have optical grade transparency. Thus, if the conductive layer 20 is provided having a thickness of 100 nm or less, the layer 20 may be provided over substantially the whole surface of the substrate 16 without compromising the optical transparency of the transparent area 12.

The abrasion resistant layer 22 is applied over the conductive layer 20 and the substrate 16. The abrasion resistant layer 22 is preferably comprised of aluminum oxide, barium fluoride, boron nitride, hafnium oxide, lanthanum fluoride, magnesium oxide, scandium oxide, silicon monoxide, silicon dioxide, silicon nitride, silicon oxy-nitride, silicon oxy-carbide, hydrogenated silicon oxy-carbide, silicon carbide, tantalum oxide, titanium oxide, tin oxide, yttrium oxide, zinc oxide, zinc selenide, zinc sulfide, zirconium oxide, zirconium titanate, or a mixture or blend thereof. More preferably, the abrasion resistant layer 22 is comprised of a composition of silicon monoxide, silicon dioxide, silicon oxy-carbide, or hydrogenated silicon oxy-carbide.

The abrasion resistant layer 60 may be applied by any vacuum deposition technique known to those skilled in the art, including but not limited to plasma enhanced chemical vapor deposition (PECVD), expanding thermal PECVD, ion assisted plasma deposition, magnetron sputtering, or electron beam evaporation. Application via expanding thermal PECVD is preferred.

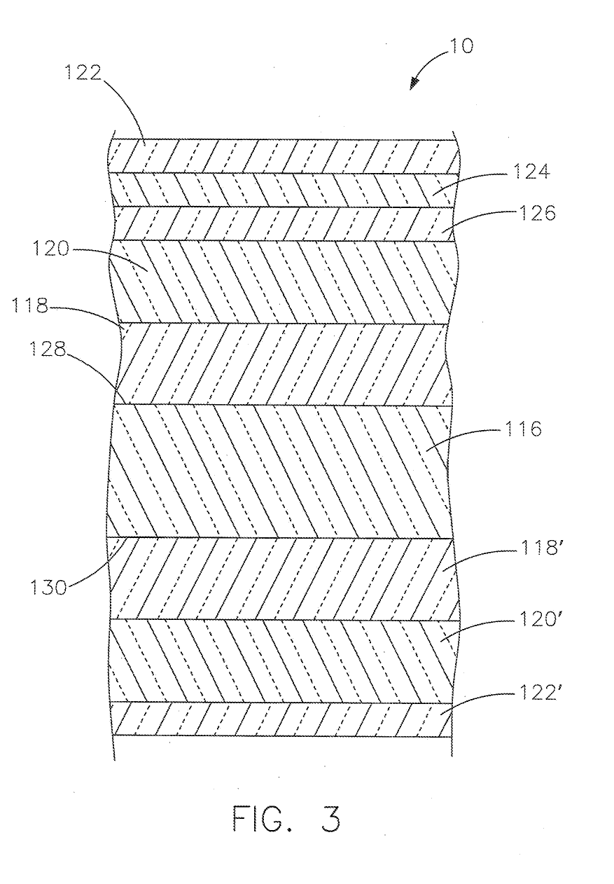

Now with reference to FIG. 3, another plastic glazing 110 is provided having a plurality of layers. As shown in FIG. 3, the plastic glazing 110 has a similar structure as in the embodiment shown in FIG. 2, including a polycarbonate substrate 116, a conductive layer 120, and an abrasion resistant layer 122. Between the substrate 116 and the conductive layer 120, a weathering layer 118 is provided to provide weatherability to the glazing 110, including protection from sun and other elements.

The weathering layer 118 is disposed adjacent to the substrate 116 and may include a single layer or multiple sub-layers. For example, the weathering layer 118 may be made of a film comprising polycarbonate (PC), polymethylmethacrylate (PMMA), a combination of PC/PMMA, polysiloxane, polyurethane, polyurethane acrylate, or any other suitable material. Further, the weathering layer 118 may be coated with a material such as acrylic, polyurethane, siloxane, or a combination of these types of material to provide a high weatherability, including long term ultraviolet (UV) protection. Further, silicone nano-particles may be blended into the weathering layer 118 or a siloxane co-polymer may be formed into the material making up the weathering layer 118 by polymerization. Preferably, the weathering layer 118 has a thickness between 10 and 40 micrometers. The weathering layer 118 may be as described in U.S. Pat. No. 6,797,384, which is hereby incorporated by reference in its entirety.

In addition to the substrate 116, the weathering layer 118, the conductive layer 120, and the abrasion resistant layer 122, the plastic glazing 110 may also optionally have a second weathering layer 124 located between the abrasion resistant layer 122 and the conductive layer 120. The weathering layer 124 has properties similar to the weathering layer 118. In addition, the plastic glazing 110 could optionally have a blackout layer or decorative print layer 126 disposed adjacent to the conductive layer 120 or disposed adjacent to any of the other layers. Further, a printed ink layer could also optionally be included (not shown), for example, a decorative ink layer, an ink layer that hides molding defects, or a resistive ink layer, such as a heater grid.

As shown in FIG. 3, the layers 116, 118, 120, 122, 124, 126 described above are applied to a first surface 128 of the substrate 116. The same or similar layers may be applied to the opposite surface 130 of the substrate 116. For example, a weathering layer 118′, a conductive layer 120′, and an abrasion resistant layer 122′, consisting of essentially the same materials and having essentially the same properties as described with respect to the weathering layer 118, the conductive layer 120, and the abrasion resistant layer 122 are shown disposed on the opposite surface 130 of the substrate 116.

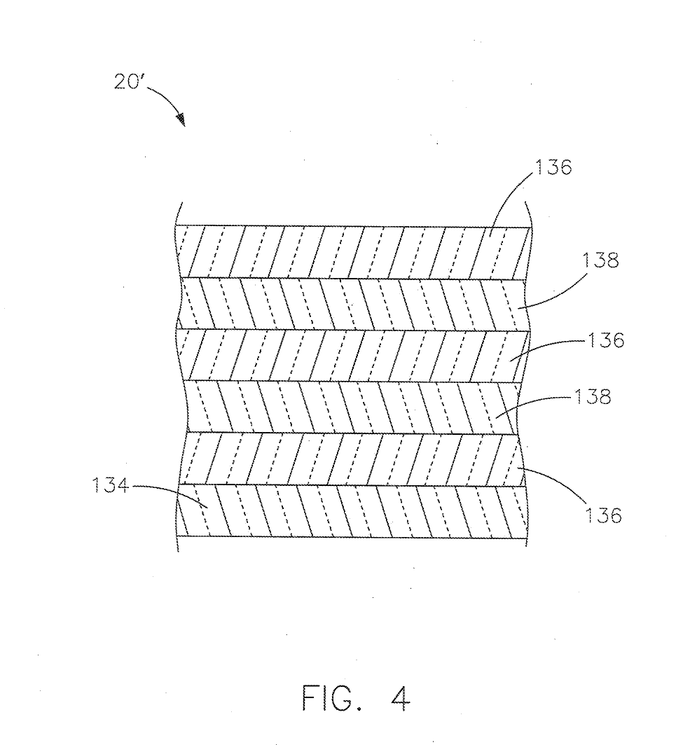

Referring now to FIG. 4, an exploded view of one embodiment of the conductive layer 20′ used in FIG. 2 and/or 3 is illustrated in further detail, in accordance with an embodiment of the present invention. In this embodiment, the conductive layer 20′ includes a plastic film layer 134 made of polyethylene teraphthalate (PET) or other similar plastic material. Adhered to the plastic film layer 134 are multiple layers of dielectric 136 separated by carbon nanotube layers 138 to produce a multi-layered stack. Each dielectric layer 136 is preferably made of SnO₂, ZnO, In₂O₃, ItO, TiO₂, SiNₓ, or similar materials. The particular material used as the dielectric layer 136 is preferably compatible to the materials of the layers that each dielectric layer 136 contacts, such that good adhesion results. For example, for a dielectric layer 136 that is in contact with a weathering layer comprising PMMA, the dielectric layer 136 may comprise an organic-like material, such as SiOₓ, and for a dielectric layer 136 in contact with the abrasion resistant layer 122, the dielectric layer 136 may comprise an inorganic-like material, such as ITO. While FIG. 4 shows only two carbon nanotube layers 138 surrounded by three dielectric layers 136, the present invention contemplates additional dielectric and carbon nanotube layers 136, 138 as desired.

The dielectric layers 136 function as a buffer layer (barrier plus adhesion interface) in order to provide an optical interference layer, for example, to redirect refracted light rays, as well as a chemical and mechanical durability layer to the carbon nanotube layers 138. Further, the dielectric layers 136 provide an excellent adhesion to the abrasion resistant layer 122 as well as the weathering layer 118.

The conductive layer 120 may be applied to the plastic glazing 110 by spray, pyrolysis or sputter deposition (R.F. sputtering, Magnetron sputtering, reactive evaporation, ion beam sputtering, PECVD), screen printing, or even dip coating, to prepare the transparent multi-layer interface coatings. The dip coating may be with alcoholic sols of surface modified 3-glycidoxypropyltrimethoxysilane, GPTS, SiOₓ and/or TiOₓ nano-particles.

In the alternative, if the conductive layer 120 may be provided as a carbon nanotube sheet or sheets, with the conductive layer 120 being attached to the substrate 116 by induction welding or any other suitable method. Induction welding may include providing a heat source, such as an electromagnetic coil, near the substrate 116 and the conductive layer 120 and activating the heat source to apply heat toward the substrate 116 and the conductive layer 120 until the surface of 128 of the substrate 116 sufficiently melts to fuse the substrate 116 to the conductive layer 120. Thereafter, the weather layer 118 and abrasion resistant layers can be applied as described above. The decorative layer 124 and additional weathering layer 126 may also be applied using the methods described herein, or by any other suitable method.

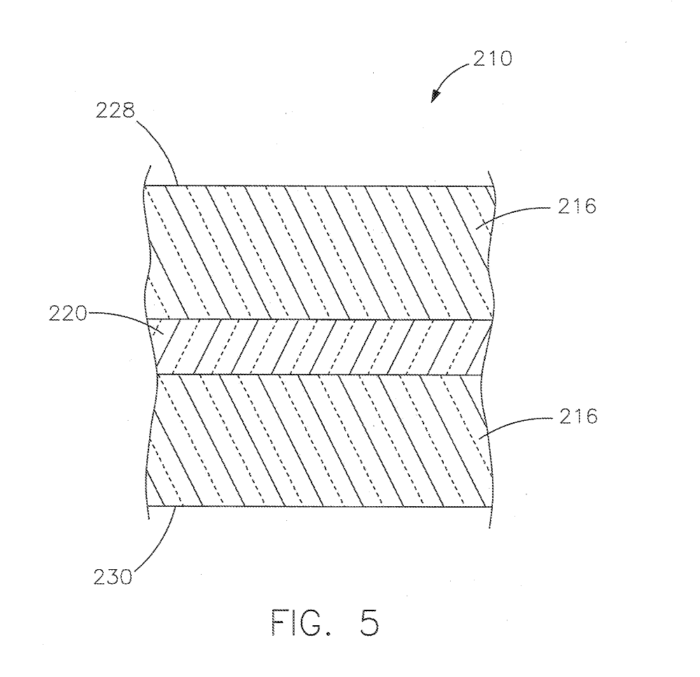

Now with reference to FIG. 5, another plastic glazing 210 is illustrated. The plastic glazing 210 has two polycarbonate substrates 216 and a conductive layer 220 disposed between the two polycarbonate substrates 216. The conductive layer 220 is comprised of carbon nanotubes, preferably carbon nanotube sheets. Weathering layers and abrasion resistant layers (not shown), may be located on the exposed surfaces 228, 230 of the substrates 216, using methods hereinbefore described. The conductive layer 220 thus forms an electric circuit between the polycarbonate substrates 216, which may serve as a transparent window defroster/defogger, an antenna, rain sensors, light sensors, touch sensors, a photochromic light control, an electroluminescent layer, or any other suitable use.

A method of forming a the plastic glazing 210 of FIG. 5 may include providing first polycarbonate plate, providing a carbon nanotube layer adjacent to the first polycarbonate plate, providing a second polycarbonate plate adjacent to the carbon nanotube layer, and delivering heat adjacent to at least one of the first and second polycarbonate plates to fuse the first and second polycarbonate plates together. The heat may be delivered via an electromagnetic coil placed next to one of the polycarbonate plates, causing the adjoining surfaces of the polycarbonate plates to melt and fuse to the carbon nanotube layer. Weathering layers 18, 118, 118′, and/or abrasion resistant layers 20, 120, 120′ may be added to one or both sides of the polycarbonate plates, via the methods described above.

Inasmuch as the foregoing disclosure is intended to enable one skilled in the pertinent art to practice the instant invention, it should not be construed to be limited thereby but should be construed to include such aforementioned obvious variations and be limited only by the spirit and scope of the following claims.

1. A plastic panel suitable for use in an automobile, the plastic panel comprising:
a polycarbonate substrate;
a conductive layer located adjacent to the polycarbonate substrate and including carbon nanotubes; and
a glazing layer located over the conductive layer, the glazing layer being formed of a material that is different from polycarbonate, the glazing layer comprising at least one of a weathering layer and an abrasion resistant layer.

2. The plastic panel of claim 1, wherein the conductive layer comprises at least one carbon nanotube sheet.

3. The plastic panel of claim 1, wherein the glazing layer comprises a weathering layer and an abrasion resistant layer.

4. The plastic panel of claim 1, further comprising a weathering layer located between the substrate and the conductive layer.

5. The plastic panel of claim 3, wherein the weathering layer is located between the conductive layer and the abrasion resistant layer.

6. The plastic panel of claim 3, wherein the weathering layer has a thickness between about 10 and 40 micrometers.

7. The plastic panel of claim 3, further comprising a decorative layer located adjacent to the weathering layer.

8. The plastic panel of claim 1, wherein the glazing layer comprises at least one of:
(a) a weathering material selected from the group consisting of polymethylmethacrylate, polysiloxane, polyurethane, and polycarbonate; and
(b) an abrasion resistant material selected from the group consisting of aluminum oxide, barium fluoride, boron nitride, hafnium oxide, lanthanum fluoride, magnesium oxide, scandium oxide, silicon monoxide, silicon dioxide, silicon nitride, silicon oxy-nitride, silicon oxy-carbide, hydrogenated silicon oxy-carbide, silicon carbide, tantalum oxide, titanium oxide, tin oxide, yttrium oxide, zinc oxide, zinc selenide, zinc sulfide, zirconium oxide, and zirconium titanate.

9. The plastic panel of claim 3, wherein the weathering layer comprises a material selected from the group consisting of polymethylmethacrylate, polysiloxane, polyurethane, and polycarbonate.

9. The plastic panel of claim 3, wherein the abrasion resistant layer comprises a material selected from the group consisting of aluminum oxide, barium fluoride, boron nitride, hafnium oxide, lanthanum fluoride, magnesium oxide, scandium oxide, silicon monoxide, silicon dioxide, silicon nitride, silicon oxy-nitride, silicon oxy-carbide, hydrogenated silicon oxy-carbide, silicon carbide, tantalum oxide, titanium oxide, tin oxide, yttrium oxide, zinc oxide, zinc selenide, zinc sulfide, zirconium oxide, and zirconium titanate.

10. The plastic panel of claim 1, wherein the conductive layer has a thickness of less than 50 nanometers.

11. The plastic panel of claim 1, wherein the conductive layer includes multiple sub-layers.

12. The plastic panel of claim 11, wherein the conductive layer comprises a plurality of dielectric layers.

13. The plastic panel of claim 3, wherein the conductive layer is a first conductive layer located adjacent to a first side of the polycarbonate substrate, the plastic panel further comprising a second conductive layer, the second conductive layer being located adjacent to a second side of the polycarbonate substrate.

14. A plastic panel suitable for use as an automobile window, the plastic panel comprising:
a first polycarbonate substrate;
a second polycarbonate substrate located adjacent to the first polycarbonate substrate; and
a conductive layer disposed between the first and second polycarbonate substrates, the conductive layer including carbon nanotubes.

15. The plastic panel of claim 14, further comprising at least one abrasion resistant layer located adjacent to at least one of the first and second polycarbonate substrates.

16. The plastic panel of claim 14, further comprising at least one weathering layer disposed adjacent to at least one of the first and second polycarbonate substrates.

17. The plastic panel of claim 14, wherein the conductive layer comprises at least one carbon nanotube sheet.

18. The plastic panel of claim 14, wherein the conductive layer comprises a plurality of dielectric layers.

19. A method of creating the plastic panel of claim 1, the method comprising:
providing the polycarbonate substrate;
disposing the conductive layer adjacent to the polycarbonate substrate;
providing a heat source near the polycarbonate substrate and conductive layer;
activating the heat source to apply heat toward the polycarbonate substrate and conductive layer; and
locating the glazing layer adjacent to the conductive layer.

20. The method of claim 19, further comprising providing the heat source as an electromagnetic coil.

21. The method of claim 19, wherein the glazing layer comprises an abrasion resistant layer, and the step of locating the glazing layer adjacent to the conductive layer comprises depositing the glazing layer using a method selected from the following: plasma-enhanced chemical vapor deposition (PECVD), expanding thermal PECVD, plasma polymerization, photochemical vapor deposition, ion beam deposition, ion plating deposition, cathodic arc deposition, sputtering, evaporation, hollow-cathode activated deposition, magnetron activated deposition, activated reactive evaporation, thermal chemical vapor deposition, and a sol-gel coating process.

22. A method of creating a substrate assembly, the method comprising:
providing a first polycarbonate plate;
providing a conductive layer adjacent to the first polycarbonate plate, the conductive layer comprising carbon nanotubes;
providing a second polycarbonate plate adjacent to the conductive layer; and
delivering heat adjacent to at least one of the first and second polycarbonate plates to fuse the first and second polycarbonate plates together.

23. The method of claim 22, further comprising delivering the heat via an electromagnetic coil.

24. The method of claim 22, further comprising adhering a weathering layer to at least one surface of at least one of the first and second the polycarbonate plates.

25. The method of claim 22, further comprising adding an abrasion resistant layer to the substrate assembly using a method selected from the group consisting of: plasma-enhanced chemical vapor deposition (PECVD), expanding thermal PECVD, plasma polymerization, photochemical vapor deposition, ion beam deposition, ion plating deposition, cathodic arc deposition, sputtering, evaporation, hollow-cathode activated deposition, magnetron activated deposition, activated reactive evaporation, thermal chemical vapor deposition, and a sol-gel coating process.
